(19) United States
(12) Patent Application Publication
(10) Pub. No.: US 2023/0030223 A1
(43) Pub. Date: Feb. 2, 2023

(54) ABSORBENT CONVERTIBLE RAISED SIDE CRIB OR CAGE LINER

(71) Applicant: Charles Weston Dudley, Destin, FL (US)

(72) Inventor: Charles Weston Dudley, Destin, FL (US)

(21) Appl. No.: 17/878,782

(22) Filed: Aug. 1, 2022

Related U.S. Application Data
(60) Provisional application No. 63/227,461, filed on Jul. 30, 2021.

(51) Int. Cl. A01K 1/015; B32B 5/02; B32B 5/26; B32B 27/12; B32B 27/30; B32B 27/36; B32B 5/08

(52) U.S. Cl. CPC A01K 1/0157; B32B 5/022; B32B 5/024; B32B 5/262; B32B 5/265; B32B 27/12; B32B 27/304; B32B 27/36; B32B 5/08; B32B 2250/04; B32B 2250/24; B32B 2270/00; B32B 2307/726; B32B 2307/73; B32B 2471/04

(57) ABSTRACT

A cage liner is disclosed having a comfortable bed and continuous sidewall which may be moisture wicking, provide comfortable padding for pets, include an additional absorbent layer, and may include a waterproof or moisture resistant backing layer. The cage liner may be disassembled to lie flat and may be easily washable, folded, and stored.

### CROSS-REFERENCE TO RELATED APPLICATIONS

This application claims the benefit of U.S. Provisional Application Ser. No. 63/227,461 filed on Jul. 30, 2021.

### TECHNICAL FIELD

The embodiments generally relate to cage liners.

### BACKGROUND

Cage liners for pets, and in particular small pets, may generally include a sheet of soft material disposed within a cage or a portion of a cage to provide comfort to a small pet or animal. Various cage liners may include absorbent material or waterproof material to absorb or contain pet messes from leaking to the bottom of a cage or outside the cage. Flat cage liners may allow mess to fall off the liner or, in the case of absorbent liners, wick moisture to the edge of the liner which may then drip into the cage. Flat cage liners may also not be ideal for burrowing pets who may attempt to get under the flat cage liner where mess may be present.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the embodiments described herein relate to a cage liner having a raised perimeter sidewall which may be moisture wicking, provide comfortable padding for pets, include an additional absorbent layer, and which may include a waterproof or moisture resistant backing layer. The cage liner may include a folding corner arrangement including corner fixtures, such as hook-and-loop straps, for securely fixing the corners of the cage liner to an exterior cage, tray, or similar structure in which the cage liner is seated. In this way, the cage liner may function as both a cage bottom or base as well as a cage liner to provide absorbent, moisture wicking functionality and waterproof, leak prevention.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates an unfolded view of the top of a cage liner consistent with this disclosure;

FIG. 2 illustrates an unfolded view of the bottom of a cage liner consistent with this disclosure;

FIG. 3 illustrates a folded and fastened view of the top of a cage liner consistent with this disclosure;

FIG. 4 illustrates a perspective view of a cage liner consistent with this disclosure;

FIG. 5 illustrates a partial exploded view of a multi-layer cage liner consistent with this disclosure;

FIG. 6 illustrates an unfolded view of the top of a cage liner consistent with this disclosure;

FIG. 7 illustrates an unfolded view of the bottom of a cage liner consistent with this disclosure;

FIG. 8 illustrates a folded and fastened view of the top of a cage liner consistent with this disclosure; and

FIG. 9 illustrates a folded and fastened view of a cage liner securely fastened to a cage consistent with this disclosure.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a cage liner made up of about four layers which may be constructed and arranged lie flat when not in use, and which may be folded and secured in a way such that the cage liner includes a raised perimeter sidewall encircling a flat portion of the cage liner. The raised perimeter sidewall may be constructed and arranged to reduce mess spillover, contain a small pet, or prevent pets from burrowing or gaining access under the cage liner. The raised perimeter sidewall may be formed by folding the cage liner along an internal seam and buttoning or otherwise fastening a plurality of corner tabs to a plurality of sidewall portions. The cage liner may include at least one or a plurality of corner fixtures, such as hook-and-loop straps, for securely fixing the corners of the raised perimeter sidewall to an exterior cage, tray, or similar structure in which the cage liner is seated. The corner fixtures may include, but not limited to, hook-and-loop straps, buttons, magnets, clasps, buckles, or the like.

The four-layer construction of the cage liner may include a first layer including a moisture wicking velvet, a second layer including a padding material, a third layer including an absorbent material, and a fourth, bottom layer including a waterproof material. According to some variations, first layer may include a 330 grams per square meter (GSM) polyester velvet, moisture wicking layer. According to some embodiments, the first layer may include a non-stick brushed synthetic velvet. According to some variations, the second layer may include a 120 GSM polyester spray bonded wadding layer. According to some variations, the third layer may include a 230 GSM, 65% polyester and 35% rayon absorbent layer. According to some variations, the fourth layer may include a 290 GSM polyvinyl chloride (PVC) waterproof layer.

Variations on the cage liner may be further understood by a description of the figures as follows.

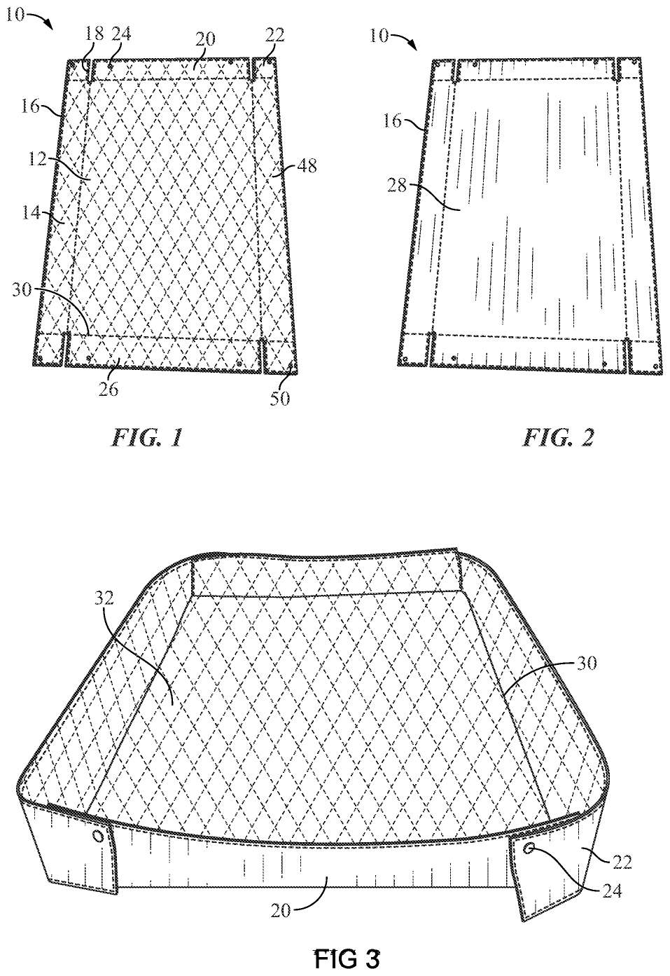

Referring to FIG. 1, a cage liner 10 that may include a first, top layer 12. The cage liner 10 may define an outer perimeter 16 and a plurality of slots 18 cut in from the outer perimeter 16. The cage liner 10 may include a plurality of sidewalls 20, 48, 14, and 26 at least partially defined by the outer perimeter 16 and the plurality of slots 18. A plurality of fastening mechanisms 24 may be disposed along a portion of the plurality of sidewalls 20, 48, 14, and 26. Cage liner may also include a plurality of corner tabs 22 which may include a second plurality of fastening mechanisms 50 constructed and arranged to fasten to the first plurality of fastening mechanisms 24. In this way, the plurality corner tabs 22 may be affixed to the plurality or sidewalls 20, 48, 14, and 26 to form a cage liner 10 having sidewalls as best seen in FIG. 3.

Referring to FIG. 2, a cage liner 10 may include a bottom layer 28, opposite the top layer 12 as best seen in FIG. 1. A second layer and a third layer (not shown) may be disposed between top layer 12 and the bottom layer 28. The layered assembly of the cage liner 10 may define an outer perimeter 16.

Referring to FIG. 3, a cage liner 10 having sidewalls may be assembled from a flat position to a folded position wherein the plurality of sidewalls 20, 48, 14, and 26 may be attached to the plurality of corner tabs 22 via the plurality of fastening mechanisms 24 and second plurality of fastening mechanisms 50 to define a bed 32 defining an inner perimeter 30.

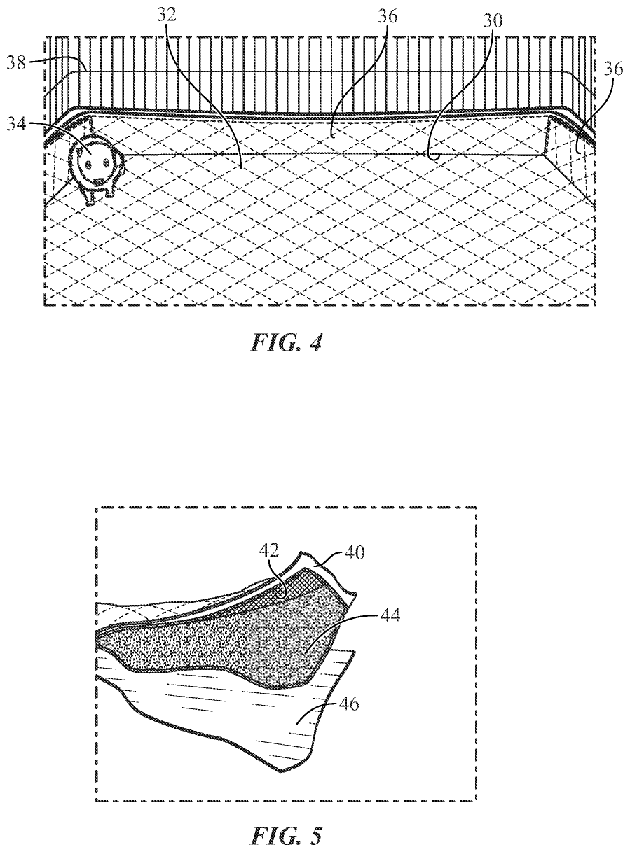

Referring to FIG. 4, in practice and in use, a cage liner may be disposed within a cage 38 to define a bed 32 defining an inner perimeter 30 and having a comfortable, leak proof continuous sidewall 36 to contain a pet 34 therein.

Referring to FIG. 5, a cage liner 10 may include a four-layer assembly including a first layer 40 that may include a 330 grams per square meter (GSM) polyester velvet, moisture wicking layer. A second layer 42 may include a 120 GSM polyester spray bonded wadding layer. A third layer 44 may include a 230 GSM, 65% polyester and 35% rayon absorbent material. A fourth layer 46 may include a 290 GSM PVC waterproof material. The first layer 40 may be disposed on the second layer 42, the second layer 423 may be disposed on the third layer 44, and the third layer 44 may be disposed on the fourth layer 46.

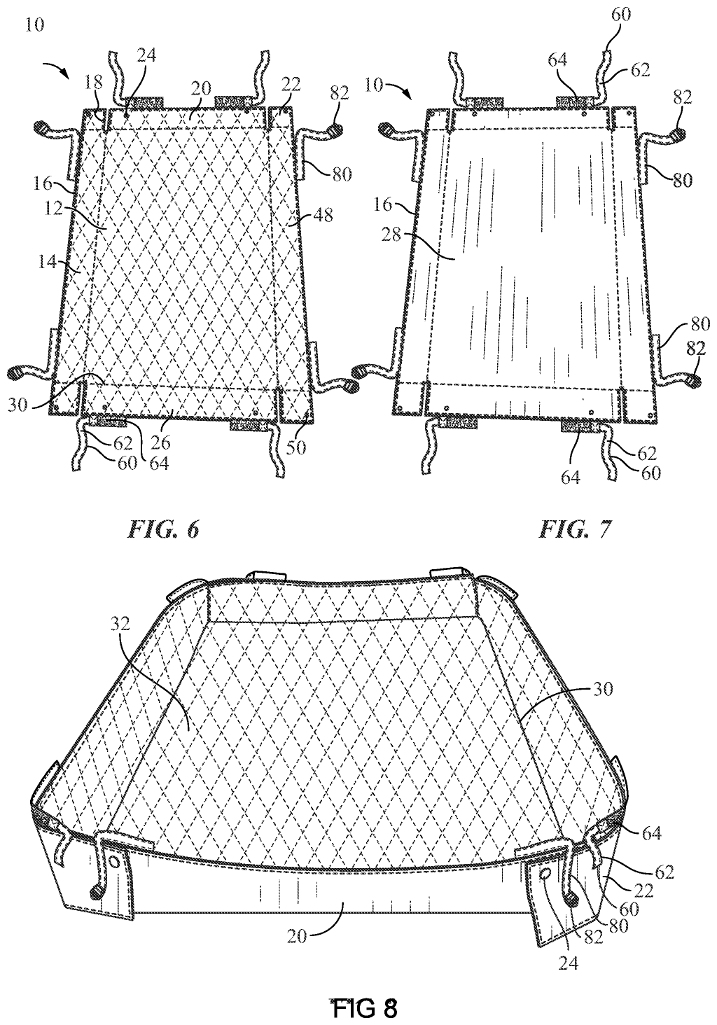

Referring to FIG. 6, a cage liner 10 that may include a first, top layer 12. The cage liner 10 may define an outer perimeter 16 and a plurality of slots 18 cut in from the outer perimeter 16. The cage liner 10 may include a plurality of sidewalls 20, 48, 14, and 26 at least partially defined by the outer perimeter 16 and the plurality of slots 18. A plurality of fastening mechanisms 24 may be disposed along a portion of the plurality of sidewalls 20, 48, 14, and 26. Cage liner may also include a plurality of corner tabs 22 which may include a second plurality of fastening mechanisms 50 constructed and arranged to fasten to the first plurality of fastening mechanisms 24. In this way, the plurality corner tabs 22 may be affixed to the plurality or sidewalls 20, 48, 14, and 26 to form a cage liner 10 having sidewalls as best seen in FIG. 8. Cage liner 10 may include a plurality of corner fixtures 60, such as hook-and-loop straps, for securely fixing the corners of the cage liner 10 to an exterior cage, tray, or similar structure in which the cage liner is seated. Corner fixtures 60 may include a temporarily adhesive face or attachment mechanism 62 for attaching the cage liner 10 to a structure. Corner fixtures 60 may also include complimentary cinch buckles 82 and cinch straps 80 which may facilitate attaching the cage liner 10 to a structure.

Referring to FIG. 7, a cage liner 10 may include a bottom layer 28, opposite the top layer 12 as best seen in FIG. 1. A second layer and a third layer (not shown) may be disposed between top layer 12 and the bottom layer 28. The layered assembly of the cage liner 10 may define an outer perimeter 16. Corner fixtures 60 may include a first surface 62 and a second surface 64 constructed and arranged to removably connect to one another, such as in a hook-and-loop arrangement. Alternatively, corner fixtures 60 may include complimentary attachment mechanisms 62 and 64, such as magnets, buttons, buckles, snaps, zippers, or the like. Corner fixtures 60 may include complimentary cinch buckles 82 and cinch straps 80 which may facilitate attaching the cage liner 10 to a structure.

Referring to FIG. 8, a cage liner 10 having sidewalls may be assembled from a flat position to a folded position wherein the plurality of sidewalls 20, 48, 14, and 26 may be attached to the plurality of corner tabs 22 via the plurality of fastening mechanisms 24 and second plurality of fastening mechanisms 50 to define a bed 32 defining an inner perimeter 30. Corner fixtures 60 may include cinch buckles 82 and cinch strap 80, or complimentary attachment mechanisms 62 and 64, such as hook-and-loop substrates, adhesives, magnets, buttons, buckles, snaps, zippers, or the like.

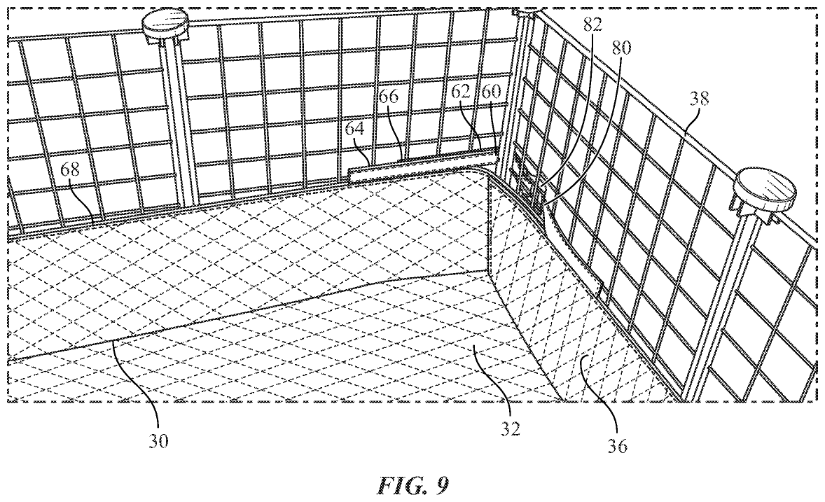

Referring to FIG. 9, a cage liner may be disposed within a cage 38 to define a bed 32 defining an inner perimeter 30 and having a comfortable, leak proof continuous sidewall 36 within a cage 38 or similar device or structure. Corner fixtures 60 may include complimentary attachment mechanisms 62 and 64, such as hook-and-loop strap, adhesives, magnets, buttons, buckles, snaps, zippers, or the like to connect 66 to one another and provide tension along the wall edge 68 of the continuous sidewall 36. Corner fixtures 60 may also include complimentary cinch buckles 82 and cinch straps 80 which may facilitate attaching the cage liner 10 to a structure such as the cage 38. Similarly, corner fixtures 60 may facilitate for attachment of the liner to a cage or similar structure to provide for raised corners of the liner such that fluid or pet waste or other materials may be prevented from sitting or collecting in liner corners and may, instead, flow towards the center of the cage liner.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a cage liner may include a four-layer assembly including a first layer, a second layer, a third layer, and a fourth layer wherein the first layer is disposed on the second layer, the second layer is disposed on the third layer, and the third layer is disposed on the fourth layer; the four-layer assembly defining an outer perimeter and a plurality of slots cut in from the outer perimeter to define a plurality of sidewalls and a plurality of tabs; a first plurality of fastening mechanisms on the plurality of sidewalls; and a second plurality of fastening mechanisms on the plurality of tabs, the first plurality of fastening mechanisms and second plurality of fastening mechanisms being removably attachable to define a bed and continuous sidewall of the cage liner.

Variation 2 may include a cage liner as in variation 1, wherein the first layer includes 330 GSM polyester velvet.

Variation 3 may include a cage liner as in any of variations 1 through 2, wherein the second layer includes 120 GSM polyester spray bonded wadding.

Variation 4 may include a cage liner as in any of variations 1 through 3, wherein the third layer includes 230 GSM, 65% polyester, and 35% rayon.

Variation 5 may include a cage liner as in any of variations 1 through 4, wherein the fourth layer includes 290 GSM PVC.

Variation 6 may include a cage liner as in any of variations 1 through 5, further including at least one corner fixture.

Variation 7 may include a cage liner as in any of variations 1 through 6, wherein the at least one corner fixture includes at least one of a hook-and-loop strap, magnet, button, buckle, snap, or zipper.

Variation 8 may include a cage liner as in any of variations 1 through 7, further including a plurality of corner fixtures.

Variation 9 may include a cage liner as in any of variations 1 through 8, wherein the plurality of corner fixtures includes a plurality of hook-and-loop straps constructed and arranged to secure the cage liner to a cage.

Variation 10 may include a cage liner as in any of variations 1 through 9, wherein the plurality of corner fixtures are constructed and arranged to provide tension within the continuous sidewall.

Variation 11 may include a cage liner as in any of variations 1 through 10, wherein the four-layer assembly is waterproof.

Variation 12 may include a cage liner as in any of variations 1 through 11, wherein the cage liner is leak-proof.

According to variation 13, a cage liner may include a four-layer assembly including a first layer including 330 GSM polyester velvet, a second layer including 120 GSM polyester spray bonded wadding, a third layer including 230 GSM, 65% polyester and 35% rayon, and a fourth layer including 290 GSM PVC wherein the first layer is disposed on the second layer, the second layer is disposed on the third layer, and the third layer is disposed on the fourth layer; the four-layer assembly further defining an outer perimeter and a plurality of slots cut in from the outer perimeter to define a plurality of sidewalls and a plurality of tabs; a first plurality of fastening mechanisms on the plurality of sidewalls; a second plurality of fastening mechanisms on the plurality of tabs, the first plurality of fastening mechanisms and second plurality of fastening mechanisms being removably attachable to define a bed and continuous sidewall of the cage liner; and a plurality of corner fixtures.

Variation 14 may include a cage liner as in variation 13, wherein the plurality of corner fixtures include at least one of a hook-and-loop strap, magnet, button, buckle, snap, or zipper constructed and arranged to provide for raised corners of the cage liner.

Variation 15 may include a cage liner as in any of variations 13 through 14, wherein the plurality of corner fixtures includes a plurality of hook-and-loop straps constructed and arranged to secure the cage liner to a cage.

Variation 16 may include a cage liner as in any of variations 13 through 15, wherein the plurality of corner fixtures are constructed and arranged to provide tension within the continuous sidewall.

Variation 17 may include a cage liner as in any of variations 13 through 16, wherein the four-layer assembly is waterproof.

Variation 18 may include a cage liner as in any of variations 13 through 17, wherein the cage liner is leak-proof.

Variation 19 may include a cage liner as in any of variations 13 through 18, wherein the first plurality of fastening mechanisms and the second plurality of fastening mechanisms include complimentary straps, magnets, buttons, buckles, snaps, or zippers.

According to variation 20, a waterproof, leak-proof cage liner may include a four-layer assembly including a first moisture wicking layer including 330 GSM polyester velvet, a second layer including 120 GSM polyester spray bonded wadding, a third layer including 230 GSM, 65% polyester and 35% rayon, and a fourth waterproof layer including 290 GSM PVC wherein the first layer is disposed on the second layer, the second layer is disposed on the third layer, and the third layer is disposed on the fourth layer; the four-layer assembly further defining an outer perimeter and a plurality of slots cut in from the outer perimeter to define a plurality of sidewalls and a plurality of tabs, the four-layer assembly being reversible to provide a moisture wicking first arrangement and a waterproof second arrangement; a first plurality of fastening mechanisms including snaps on the plurality of sidewalls; a second plurality of fastening mechanisms including snaps on the plurality of tabs, the first plurality of fastening mechanisms and second plurality of fastening mechanisms being removably attachable to define a bed and continuous sidewall of the cage liner; and a plurality of corner fixtures including a plurality of hook-and-loop straps constructed and arranged to secure the cage liner to a cage and provide tension within the continuous sidewall.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

1. A cage liner, comprising:
an assembly comprising at least one moisture absorbent layer, the assembly having an outer perimeter and a plurality of folding portions adjacent the outer perimeter to define a plurality of sidewalls;
a plurality of fastening mechanisms coupled to the assembly,
the plurality of fastening mechanisms being removably attachable when the folding portions are folded upwards to define a bed and continuous rectangular sidewall of the cage liner, the assembly not extending beyond the rectangular sidewall such that the cage liner is disposable within a cage.

2. The cage liner as set forth in claim 1, wherein the assembly comprises a top layer and a bottom layer.

3. The cage liner as set forth in claim 2, wherein the top layer and bottom layer are reversible.

4. The cage liner as set forth in claim 1, wherein a plurality of slots defines the plurality of sidewalls and a plurality of tabs.

5. The cage liner as set forth in claim 4, wherein the plurality of fastening mechanisms includes a first plurality of fastening mechanisms and a second plurality of fastening mechanisms, the first plurality of fastening mechanisms is disposed on the plurality of sidewalls; and the second plurality of fastening mechanisms is disposed on the plurality of tabs.

6. The cage liner as set forth in claim 1, further comprising at least one corner fixture.

7. The cage liner as set forth in claim 6, wherein the at least one corner fixture comprises at least one of a hook-and-loop strap, magnet, button, buckle, snap, or zipper.

8. The cage liner as set forth in claim 1, further comprising a plurality of corner fixtures.

9. The cage liner as set forth in claim 8, wherein the plurality of corner fixtures comprises a plurality of hook-and-loop straps constructed and arranged to attach the cage liner to a cage.

10. The cage liner as set forth in claim 9, wherein the plurality of corner fixtures are constructed and arranged to provide tension within the continuous sidewall.

11. The cage liner as set forth in claim 1, comprising a bottom layer that is waterproof.

12. (canceled)

13. A reversible cage liner, comprising:
an outer perimeter and
a plurality of sidewalls disposed on the outer perimeter;
a plurality of tabs extending from at least two sidewalls of the plurality of sidewalls;
the cage liner being reversible to provide a moisture wicking first arrangement and a waterproof second arrangement;
a first plurality of fastening mechanisms on the plurality of sidewalls; and
a second plurality of fastening mechanisms on the plurality of tabs, the first plurality of fastening mechanisms and second plurality of fastening mechanisms being removably attachable to define a bed and continuous sidewall of the cage liner; and
a plurality of corner fixtures.

14. The cage liner as set forth in claim 13, wherein the plurality of corner fixtures comprises at least one of a hook-and-loop strap, magnet, button, buckle, snap, or zipper constructed and arranged to provide for raised corners of the cage liner.

15. The cage liner as set forth in claim 13, wherein the plurality of corner fixtures comprises a plurality of hook-and-loop straps constructed and arranged to attach the cage liner to a cage.

16. The cage liner as set forth in claim 15, wherein the plurality of corner fixtures are constructed and arranged to provide tension within the continuous sidewall.

17. The cage liner as set forth in claim 13, wherein the first arrangement is a first layer at least partially composed of synthetic material.

18. The cage liner as set forth in claim 13, wherein the second arrangement is a second layer comprising polyvinyl chloride (PVC).

19. The cage liner as set forth in claim 13, wherein the first plurality of fastening mechanisms and the second plurality of fastening mechanisms comprise complimentary straps, magnets, buttons, buckles, snaps, or zippers.

20. A waterproof, leak-proof cage liner, comprising:
a multi-layer assembly comprising a moisture wicking top layer and a waterproof bottom layer,
the multi-layer assembly defining an outer perimeter and a plurality of folding portions disposed in the outer perimeter to define a plurality of sidewalls;
a first plurality of fastening mechanisms on the plurality of sidewalls;
a second plurality of fastening mechanisms, the first plurality of fastening mechanisms and second plurality of fastening mechanisms being removably attachable to define a bed and continuous sidewall of the cage liner when the folding portions are folded; and
a plurality of corner fixtures constructed and arranged to attach the cage liner to a cage and provide tension within the continuous sidewall.

21. The waterproof, leak-proof cage liner as set forth in claim 21 wherein the plurality of corner fixtures is configured to raise the corners of the cage liner when attached to a cage.
